(19) United States
(12) Patent Application Publication
(10) Pub. No.: US 2012/0058317 A1
(43) Pub. Date: Mar. 8, 2012

(54) ENERGY CURABLE PRIMER COATING

(75) Inventors: Norman Seung, Mason, OH (US); Richard Michelman, Cincinnati, OH (US)

(73) Assignee: MICHELMAN, INC., Cincinnati, OH (US)

(21) Appl. No.: 13/224,800

(22) Filed: Sep. 2, 2011

Related U.S. Application Data
(60) Provisional application No. 61/379,749, filed on Sep. 3, 2010.

(51) Int. Cl. C09D 147/00; C08F 2/54; B41F 33/00; B32B 15/082; B32B 27/10; B32B 27/08; C08F 2/50; B32B 3/18

(52) U.S. Cl. 428/201; 427/508; 427/496; 427/513; 428/522; 428/448; 428/463; 428/514; 428/451; 524/555; 522/173; 524/548; 522/170; 522/174; 101/483

(57) ABSTRACT

A 100% solids energy curable liquid primer coating is provided for use on a variety of substrates which cures to form a coating that provides good ink adhesion and high print quality when printed using an electrophotographic printing device. The coating includes a polyester acrylate, at least one acrylated amine, and optionally, a photoinitiator.

### CROSS REFERENCE TO RELATED APPLICATIONS

This application claims the benefit of U.S. Patent Application Ser. No. 61/379,749, entitled ENERGY CURABLE PRIMER COATING filed Sep. 3, 2010. The entire contents of said application is hereby incorporated by reference.

### BACKGROUND OF THE INVENTION

The present invention relates to a radiation curable primer coating for use on substrates, and more particularly, to a 100% solids liquid primer coating which can be applied to a variety of substrates and cured to form a coating that provides good ink adhesion and high print quality for substrates designed to be printed using an electrophotographic printing device.

In recent years, the use of on-demand, high-speed digital printing machines utilizing liquid or dry toners or inks in electrophotographic systems has become widespread. Examples of printers using such toners or inks are commercially available from Hewlett-Packard Company under the trade name HP Indigo. However, as liquid toners do not transfer well and/or adhere well to the films or paper substrates when printed on such presses, the substrates are typically treated with a coating or primer to enhance the adhesion of toners thereto.

A number of coatings or primers have been developed for use on substrates such as cellulosic or polymeric substrates which render the surface of the substrates more receptive to liquid toners. In such systems, toner images are formed on a photosensitive drum and then electrically transferred onto an intermediate transfer blanket or belt for printing on a paper or polymeric film sheet or web. One such primer coating is described in commonly-assigned U.S. Pat. No. 7,470,736, which is a water-based coating for enhancing adhesion of liquid toner to polymeric substrates. While most primer coatings currently in use are typically water-based or solvent-based, a disadvantage of such primers is that the water or solvent must be removed or dried prior to printing, which requires a significant amount of energy (e.g., heat) and time to evaporate the water or solvent. This also results in reduced line speeds when the substrate is coated and processed, as the solvent and water must be removed from the primer coating. Then the substrate, typically provided in roll form, must often be wound and transferred to a separate printing press.

Accordingly, there is a need in the art for a primer coating for use on a variety of substrates which does not require the use of water or solvents, which provides effective ink adhesion and print quality, and which may be easily and efficiently coated, cured, and printed in line.

### SUMMARY OF THE INVENTION

Embodiments of the invention meet those needs by providing a 100% solids energy curable liquid primer coating which can be applied to cellulosic, polymeric, or metallic foil substrates and cured to form a dried coating which provides good ink receptivity/adhesion and abrasion resistance. Because the primer coating does not contain water or solvents, the coating may be applied to a substrate and then cured without the need for drying so that the coated substrate can be printed in line directly after crosslinking.

According to one aspect of the invention, a 100% solids energy curable liquid primer coating is provided for enhancing ink adhesion to a substrate comprising a polyester acrylate, at least one acrylated amine, and optionally, a photoinitiator. By “100% solids,” it is meant that the coating contains no water or other solvents or carriers. As used herein, the term “monomer” also includes oligomers of that monomer.

The coating provides improved ink adhesion on a substrate over that of an uncoated substrate when printed with an electrophotographic printer. In one embodiment, the coating provides at least 70% ink adhesion on a substrate.

In one embodiment, the primer coating further includes an additional acrylate monomer which is different than the polyester acrylate and at least one acrylated amine. In one embodiment, the acrylate monomer is selected from lauryl acrylate, isodecyl acrylate, 1,6-hexanediol diacrylate, and trimethylolpropane ethoxy triacrylate.

In another embodiment, the primer coating includes at least one additional acrylated amine.

In one embodiment, the primer coating further includes an aliphatic epoxy acrylate or an aliphatic urethane acrylate.

In another embodiment of the invention, a 100% solids energy curable liquid primer coating for use on substrates is provided comprising: a) from about 35 to about 65% by weight of a polyester acrylate, b) from about 20 to about 60% by weight of at least one acrylated amine; c) from 0 to about 10% by weight of an additional acrylate monomer; and d) from about 1 to about 15% by weight of a photoinitiator. In one embodiment, the primer coating includes from 1 to about 20% by weight of at least one additional acrylated amine.

The 100% solids energy curable coating may be applied to a substrate having first and second major surfaces, where the coating is applied to at least one of the first and second major surfaces and exposed to radiation sufficient to cure the coating composition and form a coated substrate. In one embodiment, the substrate comprises paper, clay-coated or uncoated paper board, polymeric material, a metallized substrate, or metal foil.

The coating may be applied by gravure, offset gravure, flexographic, screen, or rod coating. The coating preferably has a room temperature viscosity of from about 50 to about 4,000 cps and is preferably applied at a coat weight of about 0.1 to about 2.0 g/m².

The coating may be cured using UV or electron beam radiation. Upon curing, the coating is immediately suitable for printing by an electrophotographic printing device, providing printers with the ability to apply and cure the coating in line with the printing operation.

Accordingly, it is a feature of the invention to provide a 100% solids energy curable liquid primer coating for use on a variety substrates which provides good ink and toner adhesion upon curing. Other features and advantages of the invention will be apparent from the following description.

### DETAILED DESCRIPTION OF THE PREFERRED EMBODIMENTS

Embodiments of the energy curable primer coating described herein provide many advantages over prior primer coatings in that they are 100% solids, containing no water or other solvents. Thus, when the coating is applied to a substrate, it may be immediately cured followed by printing without the need for separate heating and/or drying steps such that all of coating, curing and printing processes may be performed in an inline process, if desired.

Unless otherwise indicated, the disclosure of any ranges in the specification and claims are to be understood as including the range itself and also anything subsumed therein, as well as endpoints.

One suitable energy curable coating comprises from about 35 to 65% by weight of a polyester acrylate, from about 20 to about 60% by weight of at least one acrylated amine, from 0 to about 10% by weight of an additional acrylate monomer, and from about 1 to about 15% by weight of a photoinitiator.

Suitable polyester acrylates for use in the primer coating are commercially available from Cytec Industries under the designation Ebecryl®. A preferred polyester acrylate is Ebecryl® 888.

Suitable acrylated amines (oligoamines) are commercially available from Rahn USA Corp. under the designation Genomer®. A preferred acrylated amine is Genomer® 5142 which is included in the coating formulation in an amount of from about 20 to 60% by weight. Other suitable acrylated amines include CN371 and CN386 (commercially available from Sartomer), or an amine modified polyether acrylate oligomer such as CN551 (Sartomer).

Additional acrylated amines which may be optionally included in the coating include Ebecryl® 7100 (Cytec) in an amount of from 0 to about 10% by weight, or Genomer® 5275 (Rahn) in the amount of from 0 to about 20% by weight of the coating formulation.

Suitable acrylate monomers for use in the coating composition include lauryl acrylate, isodecyl acrylate, 1,6-hexanediol diacrylate, and trimethylolpropane ethoxy triacrylate.

Suitable photoinitiators for use in the primer coating include, but are not limited to, 1-hydroxycyclohexylphenylketone, commercially available under the designation Genocure® CPK (Rahn), dimethyl hydroxy acetophenone, commercially available under the designation Genocure® DMHA (Rahn), methyl benzoyl formate, commercially available under the designation Genocure® MBF (Rahn), benzophenone, commercially available under the designation Genocure® BP (Rahn), a liquid photoinitiator blend, commercially available under the designation Genocure® LTM (Rahn), and a blend of phosphine oxide, alpha-hydroxy ketone and a benzophenone derivative commercially available under the designation Esacure® KTO 46 (Lamberti USA).

The primer coating may further optionally include an aliphatic epoxy acrylate such as Genomer® 2235 (Rahn), or an aliphatic urethane acrylate such as Ebecryl® 8402 (Cytec) in an amount of from 0 to about 50% by weight of the coating formulation. The coating may also contain a saturated polyester resin in a urethane acrylate such as Genomer® 6043/M22 (Rahn) in an amount of from 0 to about 30% by weight of the coating formulation.

The primer coating is preferably prepared by adding the components to a mixing vessel and mixing with a stirrer at ambient temperatures until all of the components are dissolved.

The primer coating may be applied at room temperature to cellulosic substrates, polymer substrates, metallized substrates, or metallic foil substrates. Suitable cellulosic substrates include paper, clay-coated or uncoated paperboard such as clay-coated folding carton grade SBS, and uncoated liquid carton grade SBS. Suitable polymeric substrates include polypropylene, polyethylene, polyethylene terephthalate, and polylactic acid, polyvinyl chloride, polycarbonate, and polyamide. Suitable metallic foil substrates may include aluminum foil and suitable metallized substrates include, but are not limited to, metallized paper and metallized polymer films.

The coating may be applied to one or both sides of the substrate as desired. If desired, indicia may be pre-printed on the substrate prior to coating such that the coating overlies the indicia.

The primer coating composition is a 100% solids coating which is preferably applied to the substrate as a liquid. The coating composition preferably has a room temperature viscosity of from about 50 to about 4,000 cps and may be applied by flexographic, gravure, offset gravure, screen, rod coating, or other suitable means. The coating is preferably applied at a coating weight of from about 0.1 to about 2.0 g/m².

After coating, the coated substrate is then exposed to an energy source, such as a UV lamp or electron beam to cure the coating. The coated substrate is preferably exposed at a UV dosage of about 100 to 1000 mJ/cm² (H-bulb), or exposed to electron beam at a dosage ranging from 1 to 9 Mrads with a voltage range of 80 to 200 KV. After the coating has been cured, the coated substrate may be printed using an electrophotographic printer. Suitable printers for use with the coating include, but are not limited to, HP Indigo Printer Models S2000, WS4500, WS6000, and 7000 series.

In order that the invention may be more readily understood, reference is made to the following examples which are intended to illustrate the invention, but not limit the scope thereof.

### Example 1

An energy curable primer coating composition was prepared in accordance with an embodiment of the invention using the following components: polyester acrylate (Ebecryl® 888), acrylated amine (Genomer® 5142), an acrylate monomer (1,6-Hexanediol diacrylate), and a photoinitiator (Genocure® DMHA). The amounts of components in the formulations are set forth below in Table 1. All amounts are reported as weight percentages. No water or other solvents or carriers were present.

TABLE 1

| Component | Sample 1 | Sample 2 | Sample 3 |
|---|---|---|---|
| polyester acrylate | 42.50 | 52.5 | 52.5 |
| acrylated amine | 50.0 | 40.0 | 35.0 |
| 1,6-Hexanediol | 0 | 0 | 5.0 |
| diacrylate | | | |
| Photoinitiator | 7.5 | 7.5 | 7.5 |

All formulations were prepared by adding the components to a mixing vessel, and mixing with a mechanical stirrer at ambient temperature until all components were dissolved.

The liquid formulas were then applied at room temperature onto 60 lb. label stock using a 400/5 Anilox applicator at a coat weight of approximately 0.2 to 2.0 dry gsm. The coated samples were then passed through a Fusion UV unit fitted with an H-bulb at a dosage of about 700 mJ/cm² to cure the liquid coating at a web speed of about 70 ft./min.

The cured coated substrates were subjected to ink transfer and ink adhesion tests (in accordance with ASTM F 2252-03) after printing with several different models of HP Indigo digital printers. Adhesion testing was carried out immediately after printing by applying either a strip of 5 cm of 3M 230 adhesive tape to the inked surface. A 1 kg weight was rolled over the samples ten times to ensure that the tape was firmly adhered to the substrate. The tape was then removed by peeling back at an angle of approximately 120 to 150°. The percentage of ink remaining on the tested sample was then evaluated against a reference table.

The results are shown below in Table 2. The percent of ink/toner adhesion is recorded as 100% when no ink/toner is removed by the tape and 0% when all the ink/toner is removed.

TABLE 2
Ink adhesion

| Indigo Printer | | | |
|---|---|---|---|
| Model | Sample 1 | Sample 2 | Sample 3 |
| S2000 | 70% | 75% | Not tested |
| WS4500 | 70% | 70% | Not tested |
| WS6000 | Not tested | 75% | 80% |

### Example 2

An energy curable primer coating composition was prepared in accordance with an embodiment of the invention using the following components: polyester acrylate (Ebecryl® 888), acrylated amine (Genomer® 5142), additional acrylated amines: (Ebecryl® 7100) and (Genomer® 5275), an acrylate monomer (1,6-Hexanediol diacrylate), and a photoinitiator (Genocure® DMHA). The amounts of components in the formulations are set forth below in Table 3. All amounts are reported as weight percentages. No water or other solvents or carriers were present.

TABLE 3
Samples

| | | | | | | | | | | | Control |
|---|---|---|---|---|---|---|---|---|---|---|---|
| Component | 1 | 2 | 3 | 4 | 5 | 6 | 7 | 8 | 9 | 10 | (uncoated) |
| polyester | 42.5 | 52.5 | 57.5 | 52.5 | 52.5 | 50 | 50 | 55 | 40 | 47.5 | 0 |
| acrylate | | | | | | | | | | | |
| acrylated | 50 | 40 | 35 | 35 | 35 | 40 | 35 | 30 | 50 | 35 | 0 |
| amine | | | | | | | | | | | |
| (Genomer ® | | | | | | | | | | | |
| 5142) | | | | | | | | | | | |
| acrylated | 0 | 0 | 0 | 0 | 5 | 0 | 0 | 0 | 0 | 0 | 0 |
| amine | | | | | | | | | | | |
| (Ebecryl ® | | | | | | | | | | | |
| 7100) | | | | | | | | | | | |
| acrylated | 0 | 0 | 0 | 0 | 0 | 0 | 0 | 0 | 0 | 10 | 0 |
| amine | | | | | | | | | | | |
| (Genomer ® | | | | | | | | | | | |
| 5275) | | | | | | | | | | | |
| 1,6-Hexanediol | 0 | 0 | 0 | 5 | 0 | 0 | 5 | 5 | 0 | 0 | 0 |
| diacrylate | | | | | | | | | | | |
| photoinitiator | 7.5 | 7.5 | 7.5 | 7.5 | 7.5 | 10 | 10 | 10 | 10 | 7.5 | 0 |
| ink adhesion | Not | Not | Not | 75% | Not | 50% | Not | Not | Not | 75% | 20% |
| | Tested | Tested | Tested | | Tested | | Tested | Tested | Tested | | |

All formulations were prepared as described in Example 1 and were coated onto 60 lb. label stock. Samples 4, 6, and 10 from Table 3 were further applied at room temperature onto a 60 lb. label stock using an offset gravure coater with a 440 Anilox applicator roll. The coated label stock was then passed through a 400 watts/inch H-bulb at a dosage of about 150 to 200 mJ/cm² to cure the coatings. The samples were cured at a web speed of about 100 feet per minute.

The UV coated samples and the un-coated 60 lb. label stock were then printed on a HP WS 6000 Indigo Printer, using the un-coated 60 lb. label stock as the control. An ink adhesion test was carried out by applying a strip of 10 cm of 3M 230 adhesive tape to the inked surface. A 2 kg weight was rolled over the samples two times to ensure the tape was firmly adhered to the substrate. The tape was then removed by peeling back at an angle of approximately 120 to 150°. The percentage of ink remaining on the tested sample was then evaluated against a reference table. The percent of ink/toner adhesion is recorded as 100% when no ink/toner is removed by the tape and 0% when all the ink/toner is removed. As can be seen in Table 3, in comparison with the uncoated control sample, samples 4, 6, and 10 made in accordance with embodiments of the invention showed significant improvement in ink adhesion.

### Example 3

Comparative energy curable primer coating compositions were prepared as described in Example 1 using the following components:

TABLE 4

| | | | 60 lb. label stock |
|---|---|---|---|
| Component | Sample 1 | Sample 2 | (uncoated) |
| Polyester acrylate | 92.5 | 0 | 0 |
| (Ebecryl ® 888) | | | |
| acrylated amine | 0 | 92.5 | 0 |
| (Genomer ® 5142) | | | |
| Photoinitiator | 7.5 | 7.5 | 0 |
| (Genocure ® DMHA) | | | |
| Ink adhesion | 10% | 20% | 20% |

The cured coated substrates and uncoated 60 lb. label stock were printed with an HP Indigo WS 6000 printer and immediately after printing, ink adhesion testing was carried out according to the procedure described in Example 1.

Both the uncoated 60 lb. label stock and Sample 2 printed well with good ink transfer, but Sample 1 did not print well and exhibited poor ink transfer. Ink adhesion tests were performed on the areas that printed on each sample, and the results are shown in Table 4. As can be seen, the comparative compositions exhibit poor ink adhesion in comparison with coatings prepared in accordance with embodiments of the invention.

Having described the invention in detail and by reference to preferred embodiments thereof, it will be apparent that modifications and variations are possible without departing from the scope of the invention.

What is claimed is:

1. A 100% solids energy curable liquid primer coating for enhancing ink adhesion to a substrate comprising a polyester acrylate, at least one acrylated amine, and optionally, a photoinitiator; wherein said coating provides improved ink adhesion on a substrate when printed with an electrophotographic printer in comparison with an uncoated substrate.

2. The primer coating of claim 1 further including an acrylate monomer which is different than said polyester acrylate and at least one acrylated amine.

3. The primer coating of claim 2 wherein said acrylate monomer is selected from lauryl acrylate, isodecyl acrylate, 1,6-hexanediol diacrylate, and trimethylolpropane ethoxy triacrylate.

4. The primer coating of claim 1 further including at least one additional acrylated amine.

5. The primer coating of claim 1 having a viscosity of from about 50 to about 4,000 cps.

6. The primer coating of claim 1 further including an aliphatic epoxy acrylate or an aliphatic urethane acrylate.

7. The primer coating of claim 1 wherein said coating provides at least 70% ink adhesion on a substrate when printed with an electrophotographic printer.

8. A 100% solids energy curable liquid primer coating for enhancing ink adhesion to a substrate comprising:
a) from about 35 to about 65% by weight of a polyester acrylate;
b) from about 20 to about 60% by weight of at least one acrylated amine;
c) from 0 to about 10% by weight of an acrylate monomer; and
d) from about 1 to about 15% by weight of a photoinitiator.

9. The primer coating of claim 8 including from 1 to about 20% by weight of at least one additional acrylated amine.

10. A method of applying a 100% solids energy curable liquid primer coating for enhancing ink adhesion to a substrate comprising:
providing a substrate having first and second major surfaces;
applying a 100% solids energy curable liquid primer coating to at least one of said first and second major surfaces of said substrate; said coating comprising a polyester acrylate, at least one acrylated amine, and optionally, a photoinitiator;
exposing said coating composition to radiation sufficient to cure said coating composition and form a coated substrate.

11. The method of claim 10 including printing said substrate using an electrophotographic printing device.

12. The method of claim 10 wherein said radiation comprises UV or electron beam radiation.

13. The method of claim 10 wherein said primer coating is applied by gravure, offset gravure, flexographic, screen, or rod coating.

14. The method of claim 10 wherein said primer coating is applied at a coating weight to from about 0.1 to about 2.0 g/m².

15. The method of claim 10 wherein said substrate is comprised of paper, clay-coated or uncoated paperboard, foil, a polymeric material, or a metallized substrate.

16. A coated substrate, said substrate having first and second major surfaces, with at least one of said major surfaces having coated thereon a cured 100% solids primer coating comprising a polyester acrylate, at least one acrylated amine, and optionally, a photoinitiator.

17. The coated substrate of claim 16 wherein said coated substrate includes printed indicia on said substrate underlying said primer coating.

18. The coated substrate of claim 16 wherein said substrate comprises paper, clay-coated or uncoated paperboard, a polymeric material, metal foil, or metallized substrates.

19. The coated substrate of claim 16 wherein said coating has been cured by UV or electron beam radiation.
